(19) United States
(12) Patent Application Publication
(10) Pub. No.: US 2011/0157286 A1
(43) Pub. Date: Jun. 30, 2011

(54) FLUID EJECTING APPARATUS

(75) Inventors: Akihiko IKEGAMI, Okaya-shi (JP); Osamu SHINKAWA, Chino-shi (JP); Keiji HARA, Minowa-machi (JP)

(73) Assignee: SEIKO EPSON CORPORATION, Tokyo (JP)

(21) Appl. No.: 12/945,304

(22) Filed: Nov. 12, 2010

(30) Foreign Application Priority Data
Dec. 24, 2009 (JP) 2009-291962

(51) Int. Cl. B41J 2/01

(52) U.S. Cl. 347/104

(57) ABSTRACT

A fluid ejecting apparatus includes a fluid ejecting head that ejects fluid onto a target; a passing-flow-path forming member that forms a passing flow path through which the target and gas can pass from the upstream side to the downstream side in the transportation direction on the downstream side of the fluid ejecting head in the target transportation direction; a first blower that blows gas toward the downstream side in the transportation direction onto a first surface of the target in the passing flow path immediately after the first surface receives fluid ejected from the fluid ejecting head; and a second blower that blows gas toward the downstream side in the transportation direction onto a second surface of the target in the passing flow path, the second surface being opposite the first surface.

### BACKGROUND

1. Technical Field

The present invention relates to fluid ejecting apparatuses, such as ink jet printers.

2. Related Art

In general, ink jet printers (hereinafter also referred to as “printers”) that eject ink (fluid) on targets to print images, including characters and figures, are widely known as one type of fluid ejecting apparatuses (for example, see JP-A-2009-178946). The printer disclosed in JP-A-2009-178946 includes an ink jet head (fluid ejecting head) that ejects ink onto a sheet (target) and a transportation belt that is disposed so as to face the ink jet head and transports a sheet such that the sheet faces the ink jet head. When a sheet is transported from the upstream side of the transportation belt in the sheet-transportation direction onto the transportation belt, the ink jet head ejects ink onto the sheet on the transportation belt.

An output portion on which sheets having undergone ink ejection are outputted from the transportation belt is provided on the downstream side of the transportation belt in the sheet-transportation direction. A pair of rollers are provided on the upstream side of the output portion in the sheet-transportation direction. When the pair of rollers nipping a sheet therebetween are rotated, the pair of rollers exert a transportation force toward the downstream side in the transportation direction on the sheet on the transportation belt. Thus, the sheet is outputted from the transportation belt.

In recent years, printers are required to have higher printing speed. However, in the printer disclosed in JP-A-2009-178946, the above-mentioned pair of rollers are disposed near the transportation belt. Of these rollers, the roller positioned at the printing surface of a sheet (i.e., the ink-receiving surface) comes into contact with the printing surface of the sheet immediately after printing was performed on the transportation belt by ink ejection. Therefore, if the printing speed is increased in the printer disclosed in JP-A-2009-178946, this roller comes into contact with the half-dried printing surface of the sheet. This may degrade a printing image (image) formed on the printing surface of the sheet.

### SUMMARY

An advantage of some aspects of the invention is that it provides a fluid ejecting apparatus that can efficiently transport a target while preventing degradation of an image formed on the target by fluid ejection.

A fluid ejecting apparatus according to an aspect of the invention includes a fluid ejecting head that ejects fluid onto a target; a passing-flow-path forming member that forms a passing flow path through which the target and gas can pass from the upstream side to the downstream side in the transportation direction on the downstream side of the fluid ejecting head in the transportation direction of the target; a first blower that blows gas toward the downstream side in the transportation direction onto a first surface of the target in the passing flow path immediately after the first surface receives fluid ejected from the fluid ejecting head; and a second blower that blows gas toward the downstream side in the transportation direction onto a second surface of the target in the passing flow path, the second surface being opposite the first surface.

In this configuration, when the first and second blowers blow gas onto the target in the passing flow path, the target is transported by the air flow toward the downstream side in the transportation direction generated in the passing flow path. Furthermore, in this case, the gas is blown onto both the first surface immediately after receiving fluid ejected thereon and the second surface, opposite the first surface, of the target. Therefore, there is gas blown by the first blower between the first surface of the target and the inner surface of the passing-flow-path forming member, and there is gas blown by the second blower between the second surface of the target and the inner surface of the passing-flow-path forming member. As a result, the target is smoothly transported in the passing flow path to the downstream side in the transportation direction, without coming into contact with the inner surface of the passing-flow-path forming member. Accordingly, it is possible to efficiently transport the target while preventing degradation of the image formed on the target by fluid ejection.

Furthermore, in the fluid ejecting apparatus according to an aspect of the invention, the passing-flow-path forming member includes a first introducing portion that introduces gas blown by the first blower into the passing flow path, and a second introducing portion that introduces gas blown by the second blower into the passing flow path. The first introducing portion is disposed on the upstream side of the second introducing portion in the target transportation direction.

In this configuration, when the target is brought into the passing flow path, first, the gas from the first blower introduced through the first introducing portion into the passing flow path is blown onto the first surface of the target. Thus, the gas blown by the first blower urges the first surface of the target away from the inner surface of the passing-flow-path forming member. Next, when the target is brought further to the deep inner part of the passing flow path, the gas from the second blower introduced through the second introducing portion into the passing flow path is blown onto the second surface of the target. Thus, the gas blown by the second blower urges the second surface of the target away from the inner surface of the passing-flow-path forming member. In this case, because the first blower is continuously blowing gas, the first surface of the target is kept separated from the inner surface of the passing-flow-path forming member. Accordingly, it is possible to transport the target along the transportation path while assuredly preventing the first surface of the target from coming into contact with the inner surface of the passing-flow-path forming member.

Furthermore, in the fluid ejecting apparatus according to an aspect of the invention, the passing-flow-path forming member includes an entrance port through which the target is brought into the passing flow path from the upstream side of the passing-flow-path forming member in the target transportation direction; a straight flow-path portion that forms a passing flow path extending in a straight line from the entrance port toward the downstream side in the transportation direction; a non-straight flow-path portion that forms a passing flow path extending in a non-straight line from the downstream end of the straight flow-path portion toward the downstream side in the transportation direction; and an exit port provided on the downstream side of the non-straight flow-path portion in the transportation direction, through which the target is taken out of the passing flow path. The first and second blowers blow gas onto the target in the straight flow-path portion.

In this configuration, the first and second blowers blow gas while the target is transported in a straight line through a space region of the straight flow-path portion such that the first surface does not come into contact with the inner surface of the straight flow-path portion. When the target passes through a space region of the non-straight flow-path portion, there is gas blown by the first and second blowers through the space region of the straight flow-path portion between the first surface of the target and the inner surface of the non-straight flow-path portion and between the second surface of the target and the inner surface of the non-straight flow-path portion, respectively. As a result, the target is transported along the space region of the non-straight flow-path portion without coming into contact with the inner surface of the non-straight flow-path portion. Accordingly, it is possible to transport the target along the transportation path while assuredly preventing the first surface of the target from coming into contact with the inner surface of the passing-flow-path forming member.

Furthermore, in the fluid ejecting apparatus according to an aspect of the invention, the cross-sectional area of the passing flow path gradually decreases from the upstream side to the downstream side in the target transportation direction.

In this configuration, the flow rate of the gas blown by the first and second blowers gradually increases as the cross-sectional area of the passing flow path formed in the passing-flow-path forming member gradually decreases. Therefore, the target constantly receives a force pulling the target toward the downstream side in the transportation direction while being transported, making it possible to prevent a paper jam in the passing flow path. Accordingly, it is possible to assuredly transport the target along the transportation path.

Furthermore, in the fluid ejecting apparatus according to an aspect of the invention, at least one of the first and second blowers includes a heating portion that heats gas to be blown into the passing flow path.

In this configuration, warm air heated by the heating portion is blown from at least one of the first and second blowers onto the target passing through the passing flow path in the passing-flow-path forming member. Thus, it is possible to heat the first surface of the target immediately after receiving ink ejected thereon with the warm air while the target is passing through the passing flow path in the passing-flow-path forming member, thereby accelerating drying.

Furthermore, in the fluid ejecting apparatus according to an aspect of the invention, the passing-flow-path forming member includes a pair of guide portions constituting part of the inner surface of the passing flow path, the guide portions being disposed near the target passing through the flow path in the width direction of the target with slight gaps therebetween, thereby guiding the target in the transportation direction; and a driving portion that displaces at least one of the guide portions in the width direction of the target.

In this configuration, when the driving portion displaces at least one of the guide portions in the width direction of the target, the dimension of the passing flow path in the width direction of the target is changed. Thus, it is possible to transport several types of target having different widths along the passing flow path by the gas from the first and second blowers blown into the passing flow path.

### BRIEF DESCRIPTION OF THE DRAWINGS

The invention will be described with reference to the accompanying drawings, wherein like numbers reference like elements.

FIG. 1 is a cross-sectional view schematically showing the configuration of a printer according to this embodiment.

FIG. 2A is a plan view of a belt transportation device and a sheet output device, and FIG. 2B is a cross-sectional view taken along line IIB-IIB in FIG. 2A.

FIG. 3A is a cross-sectional view showing a state before the leading end of a recording sheet is brought into the sheet output device, FIG. 3B is a cross-sectional view showing a state immediately after the leading end of the recording sheet is brought into the sheet output device, FIG. 3C is a cross-sectional view showing a state in which, from the state shown in FIG. 3B, the leading end of the recording sheet is brought further to the deep inner part of the sheet output device, and FIG. 3D is a cross-sectional view showing a state immediately after the trailing end of the recording sheet leaves the belt transportation device.

FIG. 4A is a cross-sectional view showing a state immediately after the leading end of the recording sheet is brought into a curved flow-path portion of a passing flow path, and FIG. 4B is a cross-sectional view showing a state in which the leading end of the recording sheet has been transported to the vicinity of an exit port of the curved flow-path portion.

### DESCRIPTION OF EXEMPLARY EMBODIMENTS

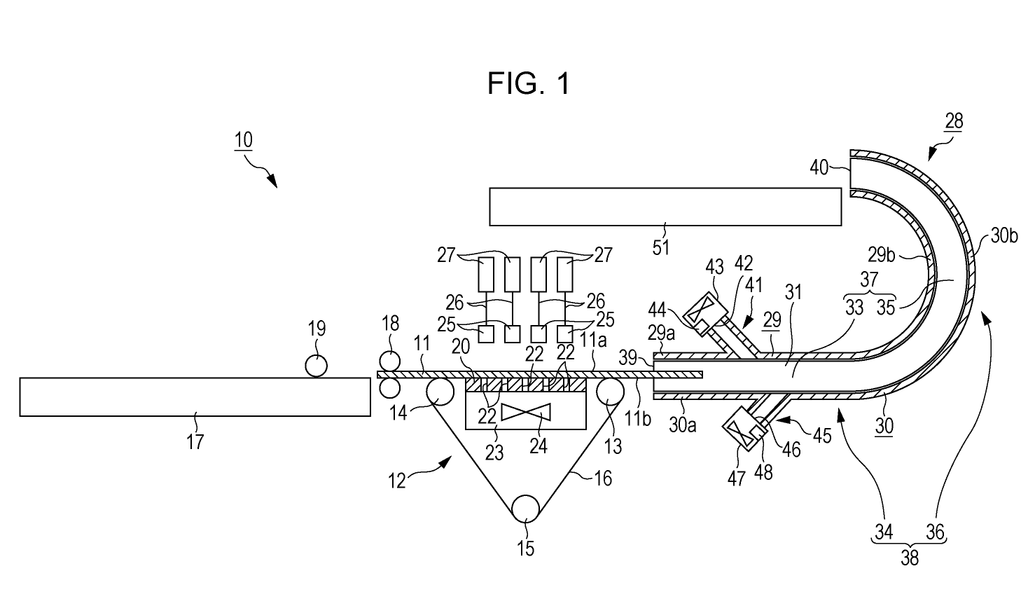

Referring to FIGS. 1 to 4, an ink jet printer, which is an embodiment of a fluid ejecting apparatus of the invention, will be described below.

As shown in FIG. 1, an ink jet printer 10, which is a fluid ejecting apparatus, includes a belt transportation device 12 that transports a recording sheet 11 serving as a target. The belt transportation device 12 includes a driving roller 13 provided on the downstream side in the transportation direction of the recording sheet 11 (the right side in FIG. 1), a driven roller 14 provided on the upstream side in the transportation direction of the recording sheet 11 (the left side in FIG. 1), and a tension roller 15 disposed slightly below the position substantially in the middle of the driving roller 13 and the driven roller 14. An endless transportation belt 16 is looped around the rollers 13, 14, and 15 so as to surround the rollers 13, 14, and 15.

A sheet feed tray 17 is provided on the upstream side of the belt transportation device 12. Gate rollers 18 are provided between the sheet feed tray 17 and the belt transportation device 12. A stack of recording sheets 11 stored in the sheet feed tray 17 are fed one by one by a sheet feed roller 19 to the belt transportation device 12 through the gate rollers 18.

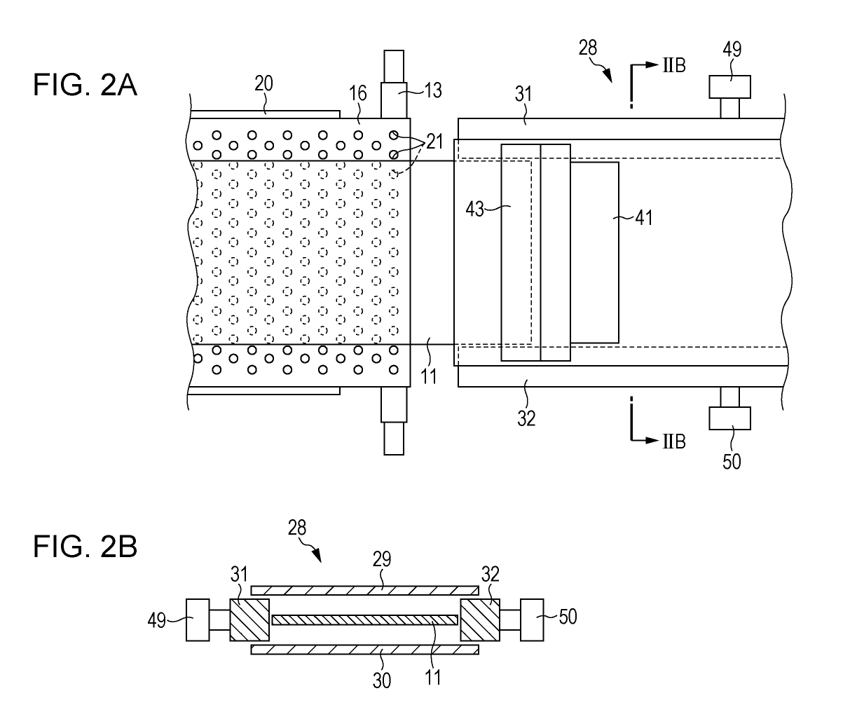

A rectangular plate-like platen 20 is provided at a position surrounded by the transportation belt 16, between the driving roller 13 and the driven roller 14, such that the top surface thereof is in into contact with the transportation belt 16. When the transportation belt 16 transports the recording sheet 11 placed thereon from the upstream side to the downstream side, the transportation belt 16 slides on the top surface of the platen 20. Furthermore, the transportation belt 16 has many air holes (see FIG. 2A) penetrating from the surface through to the back surface thereof, at which the transportation belt 16 is in sliding contact with the top surface of the platen 20. On the other hand, the platen 20 has many suction holes 22 penetrating the platen 20 vertically (in the thickness direction of the platen 20). These suction holes 22 are formed at positions corresponding to the air holes 21 in the transportation belt 16.

A substantially box-shaped induced draft fan 23 for sucking air out of the suction holes 22 is provided below the platen 20 such that it covers the openings of the suction holes 22 in the lower surface of the platen 20. The induced draft fan 23 accommodates a suction fan 24. When the suction fan 24 is driven to suck air out of the suction holes 22, negative pressure is generated and a suction force is applied to a back surface (second surface) 11b of the recording sheet 11 placed on the transportation belt 16 through the air holes 21 communicating with the suction holes 22.

A plurality of (in this embodiment, four) long line-head recording heads 25, serving as fluid ejecting heads, are disposed above the platen 20 so as to vertically face the top surface of the platen 20. The recording heads 25 extend parallel to the width direction of the transportation belt 16 (the direction perpendicular to the transportation direction of the recording sheet 11) and are disposed side-by-side in the transportation direction of the recording sheet 11. The recording heads 25 are connected to ink cartridges 27 through ink supplying tubes 26. Ink of different types (colors) is supplied to the recording heads 25 from the corresponding ink cartridges 27.

The recording heads 25 have, in the lower surfaces thereof, many nozzles (not shown) through which ink supplied from the ink cartridges 27 is ejected. By sequentially ejecting ink onto the recording sheet 11 from the nozzles at timing in accordance with the transport speed of the recording sheet 11 transported by the transportation belt 16, an image is formed on the printing surface 11a (first surface) of the recording sheet 11.

A sheet output device 28 that outputs the recording sheet 11 having undergone printing on the transportation belt 16 onto the sheet output tray 51 is provided on the downstream side of the belt transportation device 12 (the right side in FIG. 1).

As shown in FIGS. 1, 2A and 2B, the sheet output device 28 includes a pair of thin plate-like wall plates 29 and 30. These wall plates 29 and 30 respectively include straight portions 29a and 30a that extend in a straight line in the direction in which the recording sheet 11 is transported by the belt transportation device 12 (the left-right direction in FIG. 1) and curved portions 29b and 30b that are continuous with the straight portions 29a and 30a and extend in a curved line in a semi-arch shape so as to be curved upward. These wall plates 29 and 30 are disposed such that the straight portions 29a and 30a and the curved portions 29b and 30b extend parallel to each other with a predetermined distance therebetween.

The sheet output device 28 includes a pair of sealing members 31 and 32 (see FIG. 2B) that seal the space region between the pair of wall plates 29 and 30 from the front and rear side, over the entire area of the straight portions 29a and 30a and curved portions 29b and 30b of the wall plates 29 and 30. The pair of sealing members 31 and 32 are formed in a substantially rectangular shape in front view, at portions on the upstream side in the transportation direction of the recording sheet 11, i.e., at portions corresponding to the straight portions 29a and 30a of the wall plates 29 and 30, and are formed in a substantially fan shape in front view at portions on the downstream side in the transportation direction of the recording sheet 11, i.e., at portions corresponding to the curved portions 29b and 30b of the wall plates 29 and 30.

The space region defined by the pair of sealing members 31 and 32 and the straight portions 29a and 30a of the wall plates 29 and 30 is formed so as to extend in a straight line in the direction in which the recording sheet 11 is transported by the belt transportation device 12. That is, in this embodiment, the pair of sealing members 31 and 32 and the straight portions 29a and 30a of the wall plates 29 and 30 form a straight flow-path portion 34 in which a passing flow path 33, through which the recording sheet 11 can pass, extends in a straight line toward the downstream side in the transportation direction of the recording sheet 11.

Furthermore, the space region defined by the pair of sealing members 31 and 32 and the curved portions 29b and 30b of the wall plates 29 and 30 is formed in a curved line in a semi-arch shape so as to be curved upward. That is, in this embodiment, the pair of sealing members 31 and 32 and the curved portions 29b and 30b of the wall plates 29 and 30 form a curved flow-path portion (a non-straight flow-path portion) 36 in which a passing flow path 35, through which the recording sheet 11 can pass, extends in a curved line in a substantially arch shape toward the downstream side in the transportation direction of the recording sheet 11.

In this embodiment, the straight flow-path portion 34 and the curved flow-path portion 36 form a tubular passing-flow-path forming member 38 having a passing flow path 37, through which the recording sheet 11 can pass, therein. An opening in the straight flow-path portion 34, located at one end of the passing-flow-path forming member 38 in the longitudinal direction, serves as an entrance port 39 through which the recording sheet 11 having been taken out of the belt transportation device 12 is brought into the passing flow path 37. An opening in the curved flow-path portion 36, located at the other end of the passing-flow-path forming member 38 in the longitudinal direction, serves as an exit port 40 through which the recording sheet 11 having been brought into the passing flow path 37 from the belt transportation device 12 through the entrance port 39 is taken out of the passing flow path 37.

Among the pair of wall plates 29 and 30 constituting the straight flow-path portion 34, the wall plate 29, having the straight portion 29a on the upper side, has a first branch path 41 that branches off the passing flow path 33 of the straight flow-path portion 34. The first branch path 41 has substantially the same width as the width of the straight flow-path portion 34 in the direction of the width of the recording sheet 11 and is provided in the vicinity of the entrance port 39 of the passing-flow-path forming member 38. The first branch path 41 is formed obliquely in a straight line along the transportation direction of the recording sheet 11 and in a direction toward the upstream side in the transportation direction of the recording sheet 11.

A first fan 43, serving as a first blower, is connected to the first branch path 41 so as to close an opening 42 provided on the diagonally upper side. The first fan 43 accommodates rotary blades and blows air substantially uniformly in the first branch path 41 by rotating the rotary blades. The first fan 43 introduces air (gas) taken externally into the first branch path 41 through the opening 42 to the passing flow path 33 of the straight flow-path portion 34 through the first branch path 41. That is, in this embodiment, the first branch path 41 functions as a first introducing portion that introduces air blown by the first fan 43 into the passing flow path 33 of the straight flow-path portion 34. The first fan 43 has a heater 44 serving as a heating portion that heats the air taken externally into the first branch path 41 by the rotation of the first fan 43.

Among the pair of wall plates 29 and 30 constituting the straight flow-path portion 34, the wall plate 30, having the straight portions 30a on the lower side, has a second branch path 45 that branches off the passing flow path 33 of the straight flow-path portion 34. The second branch path 45 has substantially the same width as the width of the straight flow-path portion 34 in the direction of the width of the recording sheet 11 and is provided on the downstream side of the first branch path 41 in the transportation direction of the recording sheet 11. The second branch path 45 is formed in a straight line obliquely along the transportation direction of the recording sheet 11 and in a direction toward the upstream side in the transportation direction of the recording sheet 11.

A second fan 47, serving as a second blower, is connected to the second branch path 45 so as to close an opening 46 provided on the diagonally lower side. The second fan 47 accommodates rotary blades and blows air substantially uniformly in the second branch path 45 by rotating the rotary blades. The second fan 47 introduces air (gas) taken externally into the second branch path 45 through the opening 46 to the passing flow path 33 of the straight flow-path portion 34 through the second branch path 45. That is, in this embodiment, the second branch path 45 functions as a second introducing portion that introduces air blown by the second fan 47 into the passing flow path 33 of the straight flow-path portion 34. The second fan 47 has a heater 48 serving as a heating portion that heats the air taken externally into the second branch path 45 by the rotation of the second fan 47.

Furthermore, among the pair of wall plates 29 and 30 constituting the curved flow-path portion 36, a curved portion 29b of the wall plate 29 located on the inner side in the direction in which the curved flow-path portion 36 is curved is designed to have a smaller curvature than a curved portion 30b of the wall plate 30 located on the outer side in the direction in which the curved flow-path portion 36 is curved. Therefore, the cross-sectional area of the passing flow path 35 of the curved flow-path portion 36 gradually decreases toward the downstream side in the transportation direction of the recording sheet 11. The straight flow-path portion 34 and the curved flow-path portion 36 are formed such that the inner surfaces of the passing flow paths 33 and 35 are continuous with each other.

The pair of sealing members 31 and 32 are disposed in the width direction of the recording sheet 11 (the direction perpendicular to the plane of the sheet in FIG. 1) with a distance substantially equal to the recording sheet 11 in the width direction therebetween. The pair of sealing members 31 and 32 are located close to the edges, in the width direction, of the recording sheet 11 having been taken out of the belt transportation device 12 with slight gaps therebetween, thereby positioning the recording sheet 11 in the width direction. In other words, the pair of sealing members 31 and 32 function as a pair of guide portions that guide the recording sheet 11 in the transportation direction. Furthermore, actuators 49 and 50, serving as driving portions, are connected to the sealing members 31 and 32. The sealing members 31 and 32 are independently displaced in accordance with the driving of the corresponding actuators 49 and 50 in the width direction of the recording sheet 11.

Next, the operation of the ink jet printer 10, having the above-described configuration, will be described. In particular, the operation when the sheet output device 28 transports the recording sheet 11 having been brought into the passing flow path 37 toward the downstream side in the transportation direction will be described.

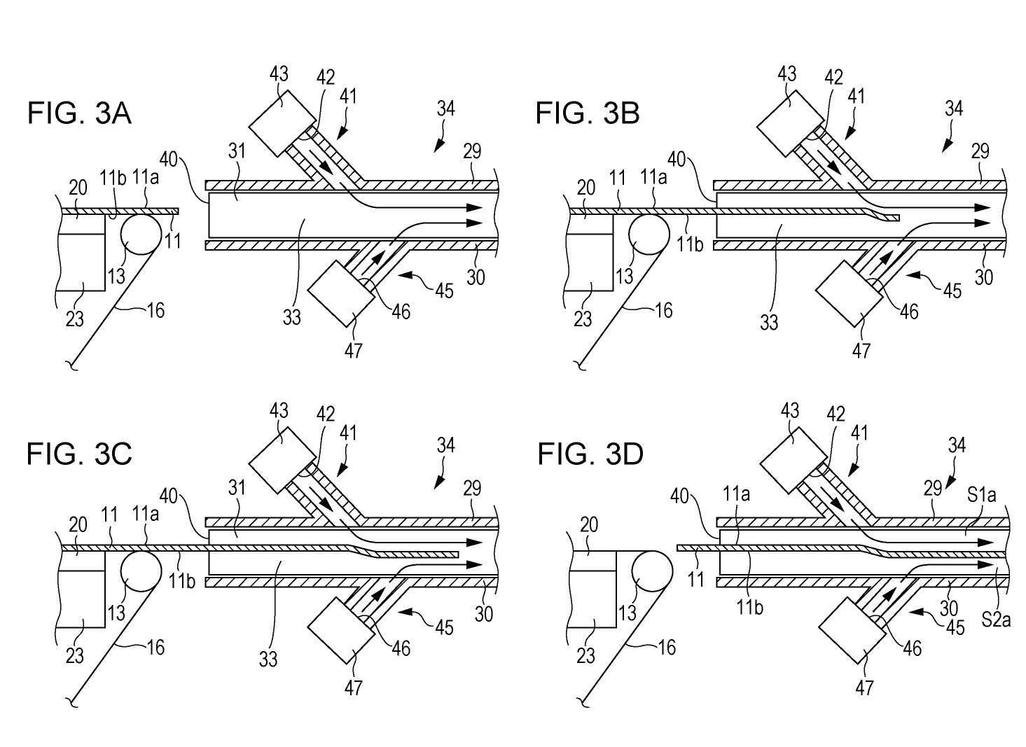

As shown in FIG. 3A, the sheet output device 28 activates the first fan 43 and the second fan 47 before the recording sheet 11 is brought from the belt transportation device 12. Then, the first fan 43 and the second fan 47 introduce air taken externally into the passing flow path 33 of the straight flow-path portion 34 through the branch paths 41 and 45. The air blown by the first fan 43 and the second fan 47 through the branch paths 41 and 45 flows obliquely toward the downstream side in the transportation direction of the recording sheet 11. That is, the air blown by the first fan 43 and the second fan 47 has a speed component toward the downstream side in the transportation direction of the recording sheet 11. Therefore, an air flow toward the downstream side in the transportation direction of the recording sheet 11 along the inner surface of the straight flow-path portion 34 is created by the air blown by the first fan 43 and the second fan 47 in the passing flow path 33 of the straight flow-path portion 34.

Next, as shown in FIG. 3B, the belt transportation device 12 drives the driving roller 13 to rotate the transportation belt 16. As a result, the recording sheet 11 placed on the transportation belt 16 is brought into the passing flow path 33 of the straight flow-path portion 34 through the entrance port 39 with the printing surface 11a facing up. The leading end of the recording sheet 11 is transported to the deep inner part of the passing flow path 33 of the straight flow-path portion 34, beyond the first branch path 41. Herein, the air blown by the first fan 43 through the first branch path 41 flows in the direction away from the inner surface of the wall plate 29 where the first branch path 41 is formed. Therefore, the leading end of the recording sheet 11 is urged in the direction away from the inner surface of the wall plate 29 where the first branch path 41 is formed, because of the air introduced from the first fan 43 into the passing flow path 33 of the straight flow-path portion 34 through the first branch path 41. The belt transportation device 12 rotates the transportation belt 16 while the recording sheet 11 is attracted to the transportation belt 16. Therefore, even when the leading end of the recording sheet 11 is separated from the transportation belt 16, the transportation force is assuredly transmitted from the transportation belt 16 to the recording sheet 11.

Next, as shown in FIG. 3C, the belt transportation device 12 continuously drives the driving roller 13 to further rotate the transportation belt 16. As a result, the leading end of the recording sheet 11 placed on the transportation belt 16 is transported to the deep inner part of the passing flow path 33 of the straight flow-path portion 34, beyond the second branch path 45. Herein, the air blown by the second fan 47 through the second branch path 45 flows in the direction away from the inner surface of the wall plate 30 where the second branch path 45 is formed. Therefore, the leading end of the recording sheet 11 is urged in the direction away from the inner surface of the wall plate 30 where the second branch path 45 is formed, because of the air introduced from the second fan 47 into the passing flow path 33 of the straight flow-path portion 34 through the second branch path 45.

Next, as shown in FIG. 3D, the belt transportation device 12 continuously drives the driving roller 13 to further rotate the transportation belt 16. As a result, the trailing end of the recording sheet 11 is separated from the transportation belt 16 and is transported into the passing flow path 33 of the straight flow-path portion 34 through the entrance port 39. In this case, the edges of the recording sheet 11 in the width direction are located close to the pair of sealing members 31 and 32, which constitute part of the inner surface of the passing flow path 33 of the straight flow-path portion 34, with slight gaps therebetween. Therefore, the passing flow path 33 of the straight flow-path portion 34 is substantially divided by the recording sheet 11 into a region S1a at the printing surface 11a of the recording sheet 11 and a region S2a at the back surface 11b of the recording sheet 11.

In the region S1a on the printing surface 11a of the recording sheet 11, air blown by the first fan 43 generates an air flow toward the downstream side in the transportation direction of the recording sheet 11. Furthermore, in the region S2a at the back surface 11b of the recording sheet 11, air blown by the second fan 47 generates an air flow toward the downstream side in the transportation direction of the recording sheet 11. In this case, the air blown by the first fan 43 generates a friction force in the air-flowing direction that acts on the printing surface 11a of the recording sheet 11. Furthermore, the air blown by the second fan 47 generates a friction force in the air-flowing direction that acts on the back surface 11b of the recording sheet 11. Therefore, the sheet output device 28 applies a driving force toward the downstream side in the transportation direction of the recording sheet 11 to the recording sheet 11, even after the trailing end of the recording sheet 11 leaves the transportation belt 16 and the transportation force transmitted from the belt transportation device 12 does not act on the recording sheet 11.

The first fan 43 and the second fan 47 are set such that they blow air into the passing flow path 33 of the straight flow-path portion 34 at substantially the same flow rate. Therefore, the driving force applied to the printing surface 11a of the recording sheet 11 by the air blown by the first fan 43 and the driving force applied to the back surface 11b of the recording sheet 11 by the air blown by the second fan 47 are substantially the same. That is, the driving force uniformly acts on both the printing surface 11a and back surface 11b of the recording sheet 11 passing through the passing flow path 33 of the straight flow-path portion 34 by the air blown by the first fan 43 and the second fan 47. Accordingly, the recording sheet 11 is transported to the downstream side in the transportation direction through the passing flow path 33 of the straight flow-path portion 34, such that the printing surface 11a and the back surface 11b are kept separated from the inner surface of the passing flow path 33 of the straight flow-path portion 34 and extend substantially parallel to the inner surface of the passing flow path 33 of the straight flow-path portion 34.

The first branch path 41 and the second branch path 45 are formed such that they have substantially the same width as the width of the straight flow-path portion 34 in the direction of the width of the recording sheet 11. The first fan 43 and the second fan 47 blow air through the branch paths 41 and 45 substantially uniformly to the entirety of the recording sheet 11 in the width direction, which is located in the passing flow path 33 of the straight flow-path portion 34. Accordingly, the printing surface 11a and back surface 11b of the recording sheet 11 are more assuredly maintained to extend substantially parallel to the inner surfaces of the wall plates 29 and 30.

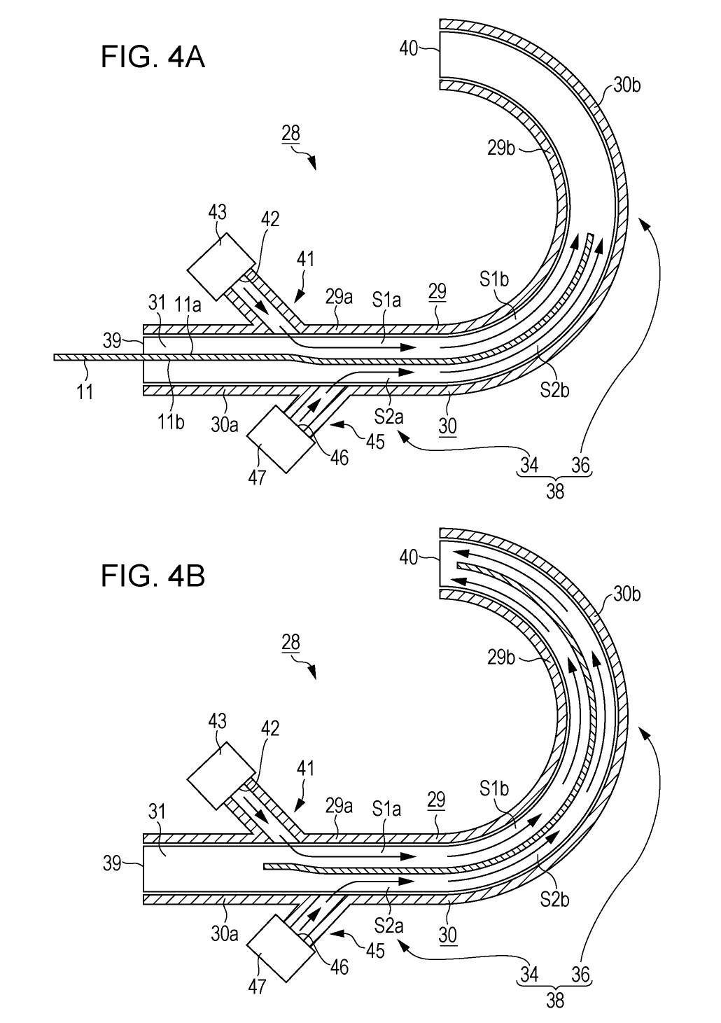

As shown in FIG. 4A, when the trailing end of the recording sheet 11 is taken out of the transportation belt 16, the leading end of the recording sheet 11 having passed through the passing flow path 33 of the straight flow-path portion 34 reaches the passing flow path 35 of the curved flow-path portion 36. In this case, the air blown by the first fan 43 flows through the region S1a at the printing surface 11a of the recording sheet 11 of the passing flow path 33 of the straight flow-path portion 34 and then flows in a region S1b at the printing surface 11a of the recording sheet 11 of the passing flow path 35 of the curved flow-path portion 36. Furthermore, the air blown by the second fan 47 flows through the region S2a at the back surface 11b of the recording sheet 11 of the passing flow path 33 of the straight flow-path portion 34 and then flows in a region S2b at the back surface 11b of the recording sheet 11 of the passing flow path 35 of the curved flow-path portion 36.

The straight flow-path portion 34 and the curved flow-path portion 36 are formed such that the inner surfaces of the passing flow paths 33 and 35 are continuous with each other. The air blown by the first fan 43 and the second fan 47 into the passing flow path 33 of the straight flow-path portion 34 flows in the passing flow path 35 of the curved flow-path portion 36 while gradually increasing the flow rate. Thus, a driving force uniformly acts on both the printing surface 11a and back surface 11b of the recording sheet 11 passing through the passing flow path 35 of the curved flow-path portion 36 by the air blown by the first fan 43 and the second fan 47. Accordingly, the recording sheet 11 is transported to the downstream side in the transportation direction through the passing flow path 35 of the curved flow-path portion 36, such that both the printing surface 11a and back surface 11b are kept separated from the inner surface of the passing flow path 35 of the curved flow-path portion 36 and extend substantially parallel to the inner surface of the passing flow path 35 of the curved flow-path portion 36.

In this embodiment, the curved flow-path portion 36 is configured such that the cross-sectional area of the passing flow path 35 gradually decreases toward the exit port 40. Therefore, the flow rate of the air blown by the first fan 43 and the second fan 47 gradually increases as the air flows through the passing flow path 35 of the curved flow-path portion 36 toward the exit port 40. Accordingly, as shown in FIG. 4B, the recording sheet 11 is transported to the exit port 40 of the passing-flow-path forming member 38 by the driving force provided by the flow of the air blown by the fans 43 and 47.

According to this embodiment, the following advantages are achieved.

(1) When air is blown by the first fan 43 and the second fan 47 onto the recording sheet 11 in the passing flow path 37 of the passing-flow-path forming member 38, an air flow is generated in the passing flow path 37 of the passing-flow-path forming member 38. Thus, the recording sheet 11 is transported by the air flow toward the downstream side in the transportation direction created in the passing flow path 37 of the passing-flow-path forming member 38. Furthermore, in this case, air is blown onto the recording sheet 11 at the printing surface 11a immediately after receiving ink ejected thereon and at the back surface 11b opposite the printing surface 11a. Therefore, there is air blown by the first fan 43 between the printing surface 11a of the recording sheet 11 and the inner surface of the passing-flow-path forming member 38, and there is air blown by the second fan 47 between the back surface 11b of the recording sheet 11 and the inner surface of the passing-flow-path forming member 38. As a result, the recording sheet 11 is smoothly transported in the passing flow path 37 to the downstream side in the transportation direction without coming into contact with the inner surface of the passing-flow-path forming member 38. Accordingly, it is possible to efficiently transport the recording sheet 11 while preventing degradation of the image formed on the recording sheet 11 by ink ejection.

(2) When the recording sheet 11 is brought into the passing flow path 37 of the passing-flow-path forming member 38, first, the air from the first fan 43 introduced through the first branch path 41 into the passing flow path 37 is blown onto the printing surface 11a of the recording sheet 11. Thus, the air blown by the first fan 43 urges the printing surface 11a of the recording sheet 11 away from the inner surface of the passing-flow-path forming member 38. Next, when the recording sheet 11 is brought further to the deep inner part of the passing flow path 37, the air from the second fan 47 introduced through the second branch path 45 into the passing flow path 37 is blown onto the back surface 11b of the recording sheet 11. Thus, the air blown by the second fan 47 urges the back surface 11b of the recording sheet 11 away from the inner surface of the passing-flow-path forming member 38. In this case, because the first fan 43 is continuously blowing air, the printing surface 11a of the recording sheet 11 is kept separated from the inner surface of the passing-flow-path forming member 38 because of the air blown by the first fan 43. Accordingly, it is possible to transport the recording sheet 11 along the transportation path while assuredly preventing the printing surface 11a of the recording sheet 11 from coming into contact with the inner surface of the passing-flow-path forming member 38.

(3) The first fan 43 and the second fan 47 blow air while the recording sheet 11 is transported in a straight line through the passing flow path 33 of the straight flow-path portion 34 such that the recording sheet 11 does not come into contact with the inner surface of the straight flow-path portion 34. When the recording sheet 11 passes through the passing flow path 35 of the curved flow-path portion 36, there is air blown by the first fan 43 and the second fan 47 through the passing flow path 33 of the straight flow-path portion 34 between the printing surface 11a of the recording sheet 11 and the inner surface of the curved flow-path portion 36 and between the back surface 11b of the recording sheet 11 and the inner surface of the curved flow-path portion 36, respectively. As a result, the recording sheet 11 is transported along the passing flow path 35 of the curved flow-path portion 36, without coming into contact with the inner surface of the curved flow-path portion 36. Accordingly, the sheet output device 28 can transport the recording sheet 11 along the transportation path while assuredly preventing the recording sheet 11 from coming into contact with the inner surface of the passing-flow-path forming member 38.

(4) The curved flow-path portion 36 is configured such that the cross-sectional area of the passing flow path 35 gradually decreases toward the exit port 40. The flow rate of the air blown by the first fan 43 and the second fan 47 gradually increases as the cross-sectional area of the passing flow path 35 of the curved flow-path portion 36 gradually decreases. Therefore, the recording sheet 11 constantly receives a force pulling the recording sheet 11 toward the downstream side in the transportation direction while being transported, making it possible to prevent a paper jam in the passing flow path. Accordingly, the sheet output device 28 can assuredly transport the recording sheet 11 along the transportation path.

(5) The first fan 43 and the second fan 47 have heaters 44 and 48 for heating air taken into the branch paths 41 and 45, respectively. Warm air heated by the heaters 44 and 48 is blown by the first fan 43 and the second fan 47 onto the recording sheet 11 passing through the passing flow path 37 of the passing-flow-path forming member 38. Thus, it is possible to heat the printing surface 11a of the recording sheet 11 immediately after receiving ink ejected thereon with warm air while the recording sheet 11 is passing through the passing flow path 37 of the passing-flow-path forming member 38, thereby accelerating drying.

(6) The pair of sealing members 31 and 32 are located close to the edges of the recording sheet 11 in the width direction with slight gaps therebetween. The recording sheet 11 is guided along the transportation path such that gaps are assuredly provided by the air flow between the recording sheet 11 and the sealing members 31 and 32. Therefore, the sheet output device 28 can transport the recording sheet 11 along the transportation path while positioning the recording sheet 11 in the width direction.

(7) When the pair of sealing members 31 and 32 move toward the edges of the recording sheet 11 in the width direction with slight gaps therebetween, the passing flow path 37 of the passing-flow-path forming member 38 is substantially divided into two regions by the recording sheet 11. Therefore, the air blown by the first fan 43 onto the region at the printing surface 11a of the recording sheet 11 in the passing flow path 37 hardly flows in the region at the back surface 11b of the recording sheet 11 in the passing flow path 37. Similarly, the air blown by the second fan 47 onto the region at the back surface 11b of the recording sheet 11 in the passing flow path 37 hardly flows in the region at the printing surface 11a of the recording sheet 11 in the passing flow path 37. Thus, there is air blown by the first fan 43 between the printing surface 11a of the recording sheet 11 and the inner surface of the wall plate 29, and there is air blown by the second fan 47 between the back surface 11b of the recording sheet 11 and the inner surface of the wall plate 30. Accordingly, in the sheet output device 28, neither the printing surface 11a nor the back surface 11b comes into contact with the inner surface of the passing-flow-path forming member 38. Thus, it is possible to assuredly prevent a transportation jam from occurring when the recording sheet 11 is transported through the passing flow path 37 of the passing-flow-path forming member 38.

(8) The pair of sealing members 31 and 32 are independently displaced in the width direction of the recording sheet 11 when the actuators 49 and 50 are driven. Therefore, the dimension of the passing flow path 37 of the passing-flow-path forming member 38 in the width direction of the recording sheet 11 is freely changed in accordance with the displacement of the sealing members 31 and 32. Accordingly, the sheet output device 28 can transport several types of recording sheets 11 having different widths.

(9) The first branch path 41 and the second branch path 45 are disposed obliquely in a straight line in the transportation direction of the recording sheet 11. Therefore, the air introduced from the first fan 43 and the second fan 47 to the passing flow path 37 of the passing-flow-path forming member 38 through the branch paths 41 and 45 flows toward the downstream side in the transportation direction, along the inner surface of the passing-flow-path forming member 38. Accordingly, the sheet output device 28 can transport the recording sheet 11 along the transportation path, by allowing the driving force of the air blown by the first fan 43 and the second fan 47 to act on the recording sheet 11.

(10) A saturated vapor layer composed of ink solvent, which is formed when part of ink solvent ejected onto the printing surface 11a is vaporized, is formed near the printing surface 11a of the recording sheet 11. In this respect, in this embodiment, the air blown by the first fan 43 flows toward the downstream side in the transportation direction in the region at the printing surface 11a of the recording sheet 11 of the passing flow path 37 of the passing-flow-path forming member 38. The air blown by the first fan 43 occasionally removes the saturated vapor layer from the vicinity of the printing surface 11a of the recording sheet 11. Therefore, vaporization of the ink solvent ejected onto the printing surface 11a of the recording sheet 11 is accelerated, whereby drying of the printing surface 11a of the recording sheet 11 can be accelerated. That is, drying of the printing surface 11a of the recording sheet 11 is accelerated while the recording sheet 11 passes through the passing flow path 37 of the passing-flow-path forming member 38. As a result, the sheet output device 28 can employ a configuration in which the recording sheet 11 immediately after printing on the transportation belt 16 is outputted on the sheet output tray 51 and, hence, can increase the printing speed on the recording sheet 11. Accordingly, the sheet output device 28 can prevent degradation of an image formed on the printing surface 11a of the recording sheet 11, even if the recording sheets 11 are sequentially stacked on the sheet output tray 51.

(11) The transportation path of the recording sheet 11 is curved upward in the sheet output device 28. Therefore, compared with the case where the entirety of the transportation path of the recording sheet 11 is provided in a straight line horizontally, the horizontal size of the entire device can be reduced.

(12) The recording sheet 11 receives transportation force from the belt transportation device 12 at the trailing end and receives driving force from the air blown by the first fan 43 and the second fan 47 at the leading end. Therefore, the belt transportation device 12 can smoothly transfer the recording sheet 11 to the sheet output device 28.

(13) The first fan 43 and the second fan 47 blow air substantially uniformly to the entire area of the recording sheet 11 in the width direction. Therefore, the sheet output device 28 can stably transport the recording sheet 11 along the transportation path such that both the printing surface 11a and back surface 11b of the recording sheet 11 are parallel to the inner surfaces of the wall plates 29 and 30.

(14) The sheet output device 28 utilizes the air blown by the first fan 43 and the second fan 47 as the driving force for moving the recording sheet 11. Herein, in the case where part of the passing flow path 37 formed in the passing-flow-path forming member 38 is curved, the space region between the recording sheet 11 and the inner surface of the passing-flow-path forming member 38 has a complex shape. In this respect, because the air blown by the first fan 43 and the second fan 47 has high flowability, the air can stay in this space region. Accordingly, even though part of the transportation path of the recording sheet 11 in the sheet output device 28 is curved, it is possible to transport the recording sheet 11 along the transportation path such that it does not come into contact with the inner surface of the passing-flow-path forming member 38.

The above-described embodiment may be modified into other embodiments as follows.

In the above-described embodiment, the actuator that displaces the sealing member in the width direction of the recording sheet 11 may be provided on only one of the pair of sealing members 31 and 32. Furthermore, the sealing members 31 and 32 may be displaced in the width direction of the recording sheet 11 manually by a user, not by providing the actuators 49 and 50 on the sealing members 31 and 32.

In the above-described embodiment, the heater may be provided on only one of the first fan 43 and the second fan 47. Furthermore, it is possible that no heaters 44 and 48 are provided on the fans 43 and 47, such that the air taken externally by the fans 43 and 47 is introduced into the passing flow path 37 of the passing-flow-path forming member 38 without being heated.

In the above-described embodiment, at least one of the first fan 43 and the second fan 47 may have a moisture absorbing filter. With this configuration, the moisture content in the introduced air is reduced by the moisture absorbing filter when the fans 43 and 47 externally introduce air into the passing flow path 37 of the passing-flow-path forming member 38 through the branch paths 41 and 45. Accordingly, drying of a printing image formed on the printing surface 11a of the recording sheet 11 can be accelerated while the recording sheet 11 passes through the passing flow path 37 of the passing-flow-path forming member 38 filled with dry air.

In the above-described embodiment, the curved flow-path portion 36 may be formed such that the cross-sectional area of the passing flow path 35 is substantially constant over the entire area in the transportation direction of the recording sheet 11 or such that the cross-sectional area of the passing flow path 35 gradually increases toward the exit port 40. In this case, it is desirable that the curved flow-path portion 36 have mechanisms for introducing air into the passing flow path 35 at several positions in the transportation direction of the recording sheet 11, so that a sufficient air flow rate can be ensured near the exit port 40 in the passing flow path 35 of the curved flow-path portion 36.

In the above-described embodiment, the first branch path 41 and the second branch path 45 may be formed such that the passing flow path 35 of the curved flow-path portion 36 is branched, so that the first fan 43 and the second fan 47 introduce air into the passing flow path 35 of the curved flow-path portion 36 through the branch paths 41 and 45.

In the above-described embodiment, the first branch path 41 and the second branch path 45 may be provided at substantially the same position in the straight flow-path portion 34 in the transportation direction of the recording sheet 11. Furthermore, the first branch path 41 may be provided on the downstream side of the second branch path 45 in the straight flow-path portion 34 in the transportation direction of the recording sheet 11.

In the above-described embodiment, the sheet output device 28 may be configured such that both the first fan 43 and the second fan 47 are driven at the same time when the recording sheet 11 is taken out of the belt transportation device 12. In this case, the sheet output device 28 may drive the first fan 43 and the second fan 47 either at the same time or at different times.

In the above-described embodiment, the sheet output device 28 may be configured such that the flow rate of the air blown by the first fan 43 is different from that of the air blown by the second fan 47. However, it is desirable that the first fan 43 blow air at a higher flow rate than the second fan 47, so that the printing surface 11a of the recording sheet 11 does not come into contact with the inner surface of the passing-flow-path forming member 38.

In the above-described embodiment, the sheet output device 28 may be configured such that the pair of sealing members 31 and 32 are in contact with the edges of the recording sheet 11 in the width direction.

In the above-described embodiment, the passing flow path 37 of the passing-flow-path forming member 38 may extend in a curved line. Furthermore, the passing flow path 37 of the passing-flow-path forming member 38 may extend in a straight line over the entire area of the transportation path of the recording sheet 11.

In the above-described embodiment, the sheet output device 28 may be configured such that it transports the recording sheet 11 printed on both surfaces. In this case, the first fan 43 blows air onto the surface (first surface) of the recording sheet 11 brought into the sheet output device 28, immediately after printing was performed on the transportation belt 16.

In the above-described embodiment, the belt transportation device 12 may be omitted. In this case, for example, a configuration in which the gate rollers 18 feed the recording sheet 11 onto the platen 20 from the sheet feed tray 17 and bring the leading end of the recording sheet 11 into the passing flow path 37 of the passing-flow-path forming member 38 may be employed.

In the above-described embodiment, the passing-flow-path forming member 38 may be made of a single material formed into a tubular shape.

In the above-described embodiment, a centrifugal fan, which blows air in the radial direction by rotating rotor blades, may be employed as a blower that blows air into the passing flow path 37 of the passing-flow-path forming member 38.

In the above-described embodiment, another material, such as a resin film, may be used as the target. However, when at least part of the passing flow path 37 of the passing-flow-path forming member 38 extends in a non-straight line, it is desirable that a material having low rigidity be used as the target.

In the above-described embodiment, the ink jet printer 10 may be a serial type or a lateral type, in which the recording heads 25 eject ink while reciprocating along the transportation plane for transporting the recording sheet 11 during printing.

In the above-described embodiments, fluid ejecting apparatuses that eject fluid other than ink may be employed as the fluid ejecting apparatus. The invention may be applied to various types of fluid consuming apparatus having fluid ejecting heads that eject fine droplets. The term “droplets” refers to a state of fluid ejected from the above-described fluid ejecting apparatus and includes particle-like droplets, teardrop-like droplets, and string-like droplets having tails. Furthermore, the fluid as used herein is a material that can be ejected from fluid consuming apparatuses. For example, liquid-phase substances may be used. Such materials include liquid having high or low viscosity, fluid, such as sol, gel water, inorganic solvent other than these, organic solvent, solution, liquid resin, and liquid metal (metal melt). In addition to liquid as one state of substance, materials in which particles of functional materials made of solids, such as pigments and metal particles, are dissolved, dispersed or mixed in solvents are included. Representative examples of the fluid include ink described in the above embodiment. Herein, ink includes various fluid compositions, such as typical aqueous ink, oil-based ink, gel ink, and hot melt ink. Specific examples of the fluid consuming apparatus include fluid ejecting apparatuses used for manufacturing, for example, liquid crystal displays, EL (electroluminescence) displays, surface light emitting displays and color filters, the fluid ejecting apparatuses ejecting liquid containing electrode material or colorant dispersed or dissolved therein; fluid ejecting apparatuses used for manufacturing biochips, the fluid ejecting apparatuses ejecting living organic materials; fluid ejecting apparatuses used as precise pipettes that eject fluid serving as a specimen; textile printing apparatuses; and microdispensers. In addition, the invention can be applied to fluid ejecting apparatuses that eject grease to precision machines, such as watches and cameras, in a pinpoint manner; fluid ejecting apparatuses that eject transparent liquid resin, such as ultraviolet curable resin, to form fine hemispherical lenses (optical lenses) used for optical communication elements; and fluid ejecting apparatuses that eject acid or alkaline etching liquid for etching substrates.

What is claimed is:

1. A fluid ejecting apparatus comprising:
a fluid ejecting head that ejects fluid onto a target;
a passing-flow-path forming member that forms a passing flow path through which the target and gas can pass from the upstream side to the downstream side in the transportation direction on the downstream side of the fluid ejecting head in the target transportation direction;
a first blower that blows gas toward the downstream side in the transportation direction onto a first surface of the target in the passing flow path immediately after the first surface receives fluid ejected from the fluid ejecting head; and
a second blower that blows gas toward the downstream side in the transportation direction onto a second surface of the target in the passing flow path, the second surface being opposite the first surface.

2. The fluid ejecting apparatus according to claim 1,
wherein the passing-flow-path forming member includes a first introducing portion that introduces gas blown by the first blower into the passing flow path, and a second introducing portion that introduces gas blown by the second blower into the passing flow path, and
wherein the first introducing portion is disposed on the upstream side of the second introducing portion in the target transportation direction.

3. The fluid ejecting apparatus according to claim 1,
wherein the passing-flow-path forming member includes an entrance port through which the target is brought into the passing flow path from the upstream side of the passing-flow-path forming member in the target transportation direction; a straight flow-path portion that forms a passing flow path extending in a straight line from the entrance port toward the downstream side in the transportation direction; a non-straight flow-path portion that forms a passing flow path extending in a non-straight line from the downstream end of the straight flow-path portion toward the downstream side in the transportation direction; and an exit port provided on the downstream side of the non-straight flow-path portion in the transportation direction, through which the target is taken out of the passing flow path, and wherein the first and second blowers blow gas onto the target in the straight flow-path portion.

4. The fluid ejecting apparatus according to claim 1,
wherein the cross-sectional area of the passing flow path gradually decreases from the upstream side to the downstream side in the target transportation direction.

5. The fluid ejecting apparatus according to claim 1,
wherein at least one of the first and second blowers includes a heating portion that heats gas to be blown into the passing flow path.

6. The fluid ejecting apparatus according to claim 1,
wherein the passing-flow-path forming member includes a pair of guide portions constituting part of the inner surface of the passing flow path, the guide portions being disposed near the target passing through the flow path in the width direction of the target with slight gaps therebetween, thereby guiding the target in the transportation direction; and a driving portion that displaces at least one of the guide portions in the width direction of the target.
